(19) United States
(12) Patent Application Publication
(10) Pub. No.: US 2006/0008092 A1
(43) Pub. Date: Jan. 12, 2006

(54) Interactive broadcast channel

(75) Inventors: Ariel Baril, Tel Mond (IL); Ron Daniel, Tel Aviv (IL)

Correspondence Address: Martin MOYNIHAN;c/o ANTHONY CASTORINA, SUITE 207, 2001 JEFFERSON DAVIS HIGHWAY, ARLINGTON, VA, 22202, US

(73) Assignee: Zoe Interactive Ltd.

(21) Appl. No.: 10/883,801

(22) Filed: Jul. 6, 2004

(51) Int. Cl. H04B 3/00; G09B 5/00

(52) U.S. Cl. 381/77; 434/307 A

(57) ABSTRACT

A broadcast music channel for a one-to-many broadcasting infrastructure, broadcasting at least vocal and instrumental parts of musical performances to currently connected users of the channel, and supporting a user operated interactive control allowing each user independently to remove a vocal part of a current performance if desired. The vocals can be replaced by subtitles, again under interactive control, and the result is a regular music channel that can be used for karaoke if and when desired.

### FIELD AND BACKGROUND OF THE INVENTION

The present invention relates to an interactive broadcast channel and, more particularly, but not exclusively to an interactive music channel.

Interactive television channels are currently becoming more common and allow broadcasters to provide games and competitions or to provide pay per view television and the like. The technology relies on a return channel which allows an individual user to send his preferences or requirements back to the broadcast provider. Cable television providers are intrinsically able to carry a return channel over their cable infrastructure. Satellite providers who provide a return channel typically do so via the telephone lines.

Music channels are widespread, well-known and popular. The music channels sometimes include interactive features such as games and competitions and occasionally allow viewers to vote, say for their favorite artiste.

A popular music game is karaoke. Karaoke has its origins as a form of entertainment for Japanese business people, who would drop into a bar with colleagues after work, have a drink, and enjoy singing popular songs. Karaoke has been entertaining people ever since its invention in the 1970's, and rapidly became established in Japanese society. The term Karaoke is a Japanese abbreviated compound word: “kara” comes from “karappo” meaning empty, and “oke” is the abbreviation of “okesutura,” or orchestra. Generally, a recorded popular song consists of vocals and accompaniment. Music tapes in which only the accompaniment is recorded were now named “karaoke.” Holding a microphone and singing a song to the accompaniment of such an empty orchestra, the user feels like a professional singer. If other customers applaud so much the better. Karaoke thus stimulates people's desire to sing. Though karaoke was at first an entertainment for business people, it grew to be a worldwide amusement, thanks to technological development.

Originally using tapes of a popular song's accompaniment, karaoke evolved to the compact disk, which can store many songs and locate the beginning of a given song immediately. This development also made possible the enhancement of video scenes to create an atmosphere suitable for each song, which could be displayed on a TV monitor along with the words.

Using technological innovations such as the video disk, laser disk, and CD graphics, karaoke is now a major entertainment industry in its own right. Family-use karaoke sets have also become popular, making the amusement formerly limited to night spots possible in the home.

A number of unexpected effects have contributed to enthusiasm for the spread of karaoke technology. First of all, as karaoke displays the words and scenes of a song on a monitor, it has been attracting the attention of educators wishing to improve literacy rate. More generally, it has been noted that since the popularization of records, radio, and TV, people have become passive receivers of entertainment. The advent of karaoke, requiring active participation, is a small step in the correction of this phenomenon and provides a contribution to the history of musical entertainment.

Home karaoke machines exist. U.S. patent application Ser. No. 10/089,828 filed Apr. 4, 2002 describes an interactive device that is designed to be connected over the Internet to a website that provides karaoke material, that is songs with appropriate video backgrounds and with the words and any singing instructions as subtitles, but without the vocal part of the track. The device can be connected to a regular television set to display the karaoke material to allow users to sing along.

A not truly interactive Karaoke channel was proposed in the late nineteen nineties in Singapore as a TV Channel called KTV. The channel allowed users to order songs via telephone or e-mail.

The above examples either required specialist equipment or in any event required a special purchase to be made. Consumers were apparently reluctant to make the investment when the only use was for Karaoke.

Aside from Karaoke, talent competitions are popular in which competitors simply sing songs and receive votes. Current technology does not provide specific devices to support such competitions.

There is thus a widely recognized need for, and it would be highly advantageous to have, a musical entertainment system devoid of the above limitations.

### SUMMARY OF THE INVENTION

According to one aspect of the present invention there is provided a broadcast music channel for a one-to-many broadcasting infrastructure, said channel broadcasting at least vocal and instrumental parts of musical performances to currently connected users of said channel, said broadcast music channel supporting a user operated interactive control allowing each user independently to remove a vocal part of a current performance if desired.

Preferably, said channel further broadcasts a text part of a respective musical performance, said text part comprising at least one of lyrics of said performance and instructions for performing said lyrics.

The channel may be configured to support an additional interactive control for including or removing said text part independently by each respective user.

Preferably, said channel comprises a plurality of text parts of said respective musical performance, said text parts being respectively different and selectable by said additional interactive control.

The channel may be configured to use a one-to-many broadcast channel for delivering said vocal and instrumental parts to said users and to use an interactive channel to support said interactive control and to send said text part.

The channel may be configured to use a one-to-many broadcast channel for delivering said vocal, said instrumental and said text parts to said users and to use an interactive channel to support said interactive control.

Preferably, said broadcast infrastructure is any one of a group comprising: terrestrial broadcasting infrastructure, cable television infrastructure, satellite broadcasting infrastructure, Internet infrastructure, a radio infrastructure and cellular telephony infrastructure.

The channel may comprise a graphical broadcast part to accompany said performance.

The channel may comprise a video performance part.

The channel may comprise an animated broadcast part to accompany performances on said channel.

Preferably, said animated broadcast part is a figure having an operative connection to a music part of said broadcast to react to a beat of said music part.

Preferably, said animated part is user selectable from a plurality of characters.

Preferably, each of said user selectable characters has a different behavior profile.

According to a second aspect of the present invention there is provided a method for simultaneously providing a broadcast music channel and an interactive karaoke channel, to users at least some of whom are equipped with interactive control, comprising:
broadcasting a musical performance comprising a musical part and a vocal part to all current users of said channel, and
providing said interactively equipped users with an interactive control to remove said vocal part, independently of other viewers, thereby to view only said musical part of said performance.

The method may comprise providing a first text part of said performance, said text part comprising at least one of lyrics and performing instructions.

The method may comprise providing an interactive control for adding or removing said text part to said performance independently of other users.

The method may comprise providing at least one additional text part of a respective performance, said additional text part being different from said first text and selectable by interactive control as an alternative to said first text part.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing a standard broadcast infrastructure capable of supporting an interactive broadcast channel;

FIG. 2 is a simplified schematic diagram illustrating a way in which a music channel can broadcast in parts, to allow interactive selection of the parts to provide a karaoke service according to preferred embodiments of the present invention;

FIG. 3 is a simplified schematic diagram illustrating one preferred embodiment of how the channel parts of FIG. 2 can be configured to provide a music channel that can be interactively rearranged to provide karaoke;

FIG. 4 is a simplified schematic diagram showing an alternative configuration for a music channel that can be interactively rearranged to provide karaoke;

FIG. 5 is a schematic diagram of a menu screen for an interactive channel service using embodiments of the present invention;

FIG. 6 is a schematic diagram of a screen of a music channel being used interactively according to an embodiment of the present invention, and showing different regions of the screen;

FIG. 7 is a simplified diagram showing an interactive music channel being broadcast over third generation cellular telephony infrastructure; and

FIG. 8 is a simplified diagram showing an interactive music channel being broadcast over Internet infrastructure.

### DESCRIPTION OF THE PREFERRED EMBODIMENTS

The present embodiments provide a channel, or package of channels, which is a standard music channel for those users who do not have or do not choose to use interactive capabilities but for those users who do, the channel is an interactive user participation channel allowing removal of the vocal part of a performance so that the user or users can replace the vocals with their own singing. In one embodiment the lyrics are broadcast as subtitles of the regular channel. In another embodiment the lyrics as subtitles, perhaps with performance instructions, can be added interactively to replace the vocal part, just as with a karaoke machine. In yet another embodiment the user is able to choose between different sets of lyrics, say one set for solo singing and one set for duets.

The principles and operation of a music channel which doubles as an interactive user participation or karaoke channel according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

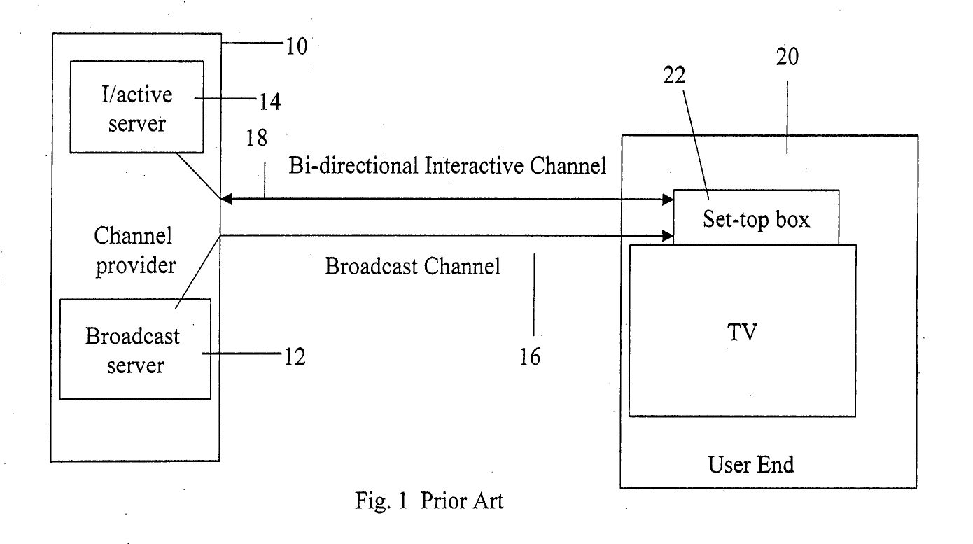

Reference is now made to FIG. 1, which illustrates an infrastructure for broadcasting an interactive channel. A channel provider 10 has a broadcast server 12 and an interactive server 14. The broadcast server 12 sends a constant stream of material to everyone who is tuned in over a one-to-many broadcast channel 16. Interactive server 14 is connected to a two-way channel 18 and can both send material to a user end 20 and receive material by return. The outward bound leg of the channel 18 is a one-to-one channel which can modify material sent to an individual viewer and send different material to different viewers. The inward bound leg of the channel 18 allows a viewer to send signals to the channel provider 10. Interactive server 14 co-ordinates the interactive service that is provided so that a viewer is sent the signals he requests and his incoming signals are acted upon in the appropriate way, for instance to modify the signals sent back to the viewer.

As an example of the use of an interactive service on a regular channel it is possible to provide the viewer with the facility to request subtitles. The regular channel is broadcast to the viewer, along with all other viewers, over broadcast channel 16 to the viewer at user end 20. The individual viewer then interacts with his set-top box 22 to request subtitles and a corresponding signal is sent via the inward bound leg of interactive channel 18 to interactive server 14. Interactive server 14 then starts sending the subtitles for the current program to the viewer who has requested it, via the outward bound leg of interactive channel 18. Thus the viewer who requested it sees the program with subtitles whilst other viewers see the same program without subtitles.

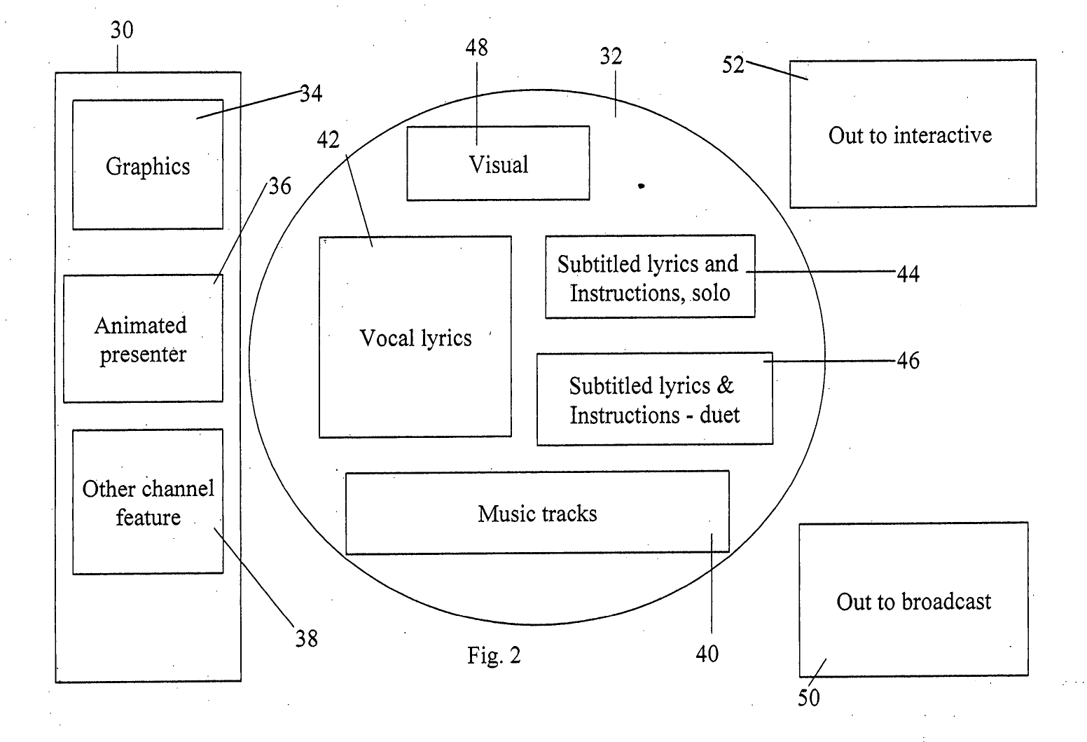

Reference is now made to FIG. 2, which is a schematic diagram illustrating various constituent parts of a music channel broadcast according to a preferred embodiment of the present invention. In the current art all of these parts are broadcast as a single unit over the broadcast channel 16 to all viewers. First of all the broadcast may be divided into features of the channel itself 30 and features belonging to the current performance 32. The channel itself may provide such features as background graphics 34, and an animated presenter 36, say who presents the performances or acts as a karaoke presenter. Other features 38 may also be present. The performance 32 comprises music tracks 40, a vocal track 42, and may additionally comprise the lyrics as subtitles, 44. For karaoke purposes the lyrics may be provided with singing instructions, and in a preferred embodiment there may be provided more than one set of lyrics, thus one set 44 for a solo, and another set 46 for a duet. In the case of the performance being a music video a visual part 48 may also be provided.

The different parts of the channel and performance can be individually assigned either to a broadcast output 50 for sending to the broadcast server, or to the interactive output 52 for sending to the interactive server. In general the broadcast channel has the bulk of the capacity and the interactive channel has far less capacity so as much data as possible should be sent via the broadcast channel and use of the interactive channel should try to minimize data quantity as much as possible.

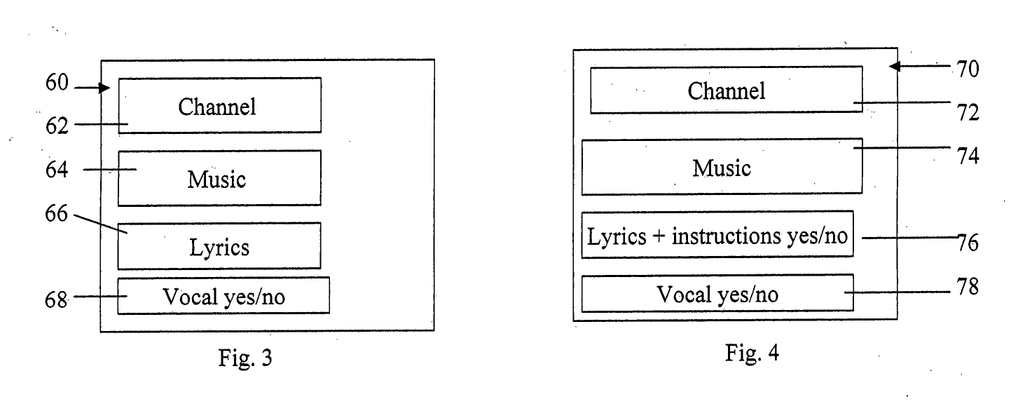

Reference is now made to FIG. 3, which is a simplified diagram showing one embodiment of how the music channel can be configured using the parts shown in FIG. 2 to provide a service 60 that is a simple music channel for those who require or do not have interactive capability and is a karaoke channel for those who require it. In FIG. 3 the general channel features 62, music 64 and lyric subtitles 66 are constantly broadcast over the broadcast channel for all users, with the option of the user being able to interactively remove the vocal part 68 so as to use the channel for karaoke. If the animated figure is intended specifically for karaoke then it is only sent when the vocals are removed and is then sent over the interactive channel.

Reference is now made to FIG. 4, which is a simplified diagram showing a second embodiment of how the music channel can be configured using the parts in FIG. 2 to provide a service 70 that is a simple music channel as before for those who require or do not have interactive capability and is a karaoke channel for those who require it. In FIG. 3 the general channel features 72, and music 74 are constantly broadcast over the broadcast channel for all users, with the option of the user being able to interactively add the lyrics with performance instructions 76 and remove the vocal part 78 so as to use the channel for karaoke. If the animated figure is intended specifically for karaoke then it is only sent when the vocals are removed and is then sent over the interactive channel.

It is noted that there are two preferred ways of removing the vocal part from the channel as seen by the viewer. In a first way the vocal part, which is relatively data heavy, is broadcast via the main broadcast channel. When the user requests the removal of the vocal part, he is in fact moved over to another broadcast channel, which broadcasts the music and graphics but not the vocal part of the signal. As an alternative the main broadcast channel may broadcast the channel without the vocals, and the interactive channel may supply the vocals. Thus the vocals can be removed at the user's request. The latter embodiment is particularly suitable for cable TV, where the interactive channel is of relatively high capacity and is available to all viewers.

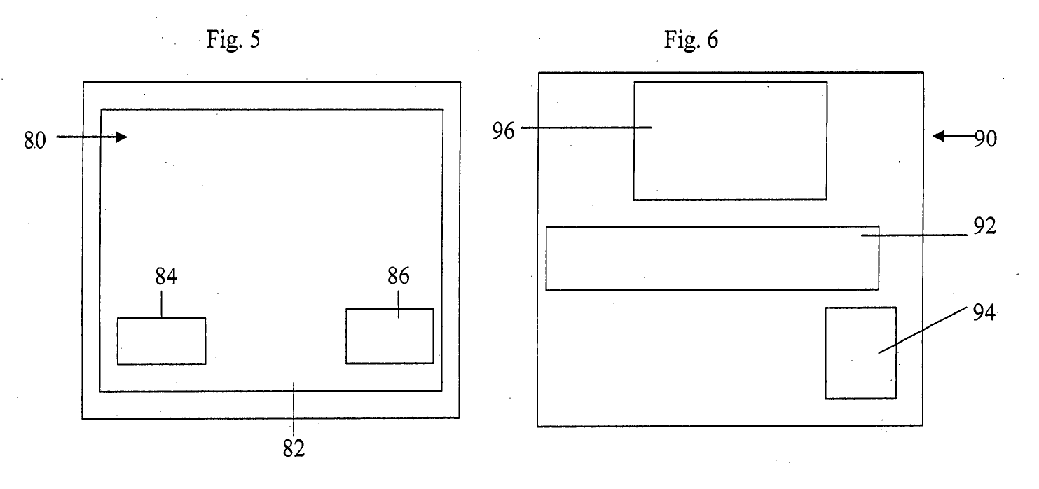

In a preferred embodiment a bundle of music channels is provided. The bundle may be completely independent channels, or they may be linked together using a master screen or links may be provided from one channel to another. Reference is now made to FIG. 5, which is a simplified diagram illustrating a main screen 80 which provides a first channel and also supplies links to other music channels in the bundle. In the master screen a first screen 82 contains the currently active channel and two or more mini-screens 84, and 86, each represent a different channel and can be selected, using the remote control, to take the viewer to the channel he requires. Thus one channel may be in accordance with the embodiment of FIG. 3, with subtitles as part of the main broadcast, a second channel may be in accordance with the embodiment of FIG. 4 in which the viewer selects whether to add the subtitles, and a third channel may follow either embodiment but cater for a different taste in music. All of the channels in the bundle may have links to all other channels. Alternatively one of the channels may be a master channel carrying links to the other channels.

Reference is now made to FIG. 6, which is a simplified diagram illustrating a screen for a music channel being used in interactive mode. Screen 90 comprises a subtitle region 92 for showing the lyrics and performance instructions of a current performance. As in a standard karaoke machine, the words preferably appear according to the rhythm of the current song, and in practice provide the singer with a timing signal for the song. An animation region 94 contains an animated character, including a character having a true-to-life appearance, who might be presenting karaoke in competition format or the like. A video region 96 is shown here occupying the middle top part of the screen but is equally well able to occupy any other part or indeed the entire screen. In the latter case the other features are superimposed thereon. The video region typically shows video clips or graphics co-ordinated with the characteristics of the current performance.

Returning to the animation region 94, and the animated character may in one embodiment be selected by the user from a range of characters and may for example dance in time with the music during the performance, tell contestants to get ready, make comments following the performance, introduce the next song and the like. The character is in this embodiment provided via the interactive server. Depending on processing capacity at the interactive server, not all of the selectable animated characters need behave in the same way or say the same things and the characters may be provided with different personalities for the entertainment of the participants, based on behavior profiles. Thus one character may be the bad character, making snide remarks such as advising contestants to keep their day jobs, whilst another character may provide words of encouragement.

In one preferred embodiment for groups the animated character may select the order in which contestants appear. Thus different contestants may be supplied with a number and interaction used to tell the system the numbers of the contestants. The animated character then selects the numbers at random for the different songs. Such a feature is particularly useful to overcome reticence by contestants. Alternatively the users may be shown the list of upcoming songs, and may themselves select the order of singers based on their personal preferences.

In a variation of the above for a video on demand (VOD) service, the users may in fact choose their own playlist of songs from a menu.

The animated character allows the same music channel to be used in different ways since it directs user interactions. Thus the music channel can be used in the classic karaoke style for individuals to sing solo. Alternatively, the character can direct a group of users to sing together to provide a group singing feature. In a particularly preferred embodiment the animated character provides the direction for a singing competition. A number of competitors are each given numbers. They take turns to sing, and, under the guidance of the animated character, assign votes to the other competitors. The interactive feature adds up the votes over the course of the competition, which may be defined as a number of rounds, and a winner is declared.

A further way the channel may be used is for singing along with the original vocals. In this case the vocals are not removed, but the subtitles may be added so that the user sees the lyrics and the timing.

The animated characters may each be supplied with a dance profile that allows them to dance in accordance with the rhythm and character of the music. Thus the character may move in accordance with the rhythm of the song, and also vary the kind of movement in accordance with the kind of song. Thus for disco music the character may move its arms and legs, and for quite music it may simply move its body from side to side. The animated characters thus provide dance cues for the participants.

It will be appreciated that whilst in the above, reference has been made to viewers, to lyrics as subtitles and to visual parts, the same principles apply to providing the service over radio. Again the main channel is broadcast to all users and the vocal track may be interactively removed to support a karaoke game or the like. As described above the vocal track may be removed by moving the user to a neighboring channel or by providing the vocal track over an interactive connection as convenient. In genuine radio for a radio device the user has to know the lyrics since these cannot be displayed. However the embodiment may be applied to a radio channel of a cable or satellite TV package, in which case the receiving device is a television set and the radio channel is shown with background graphics. In this case the lyrics can conveniently be supplied via the associated interactive channel and displayed with the background graphics.

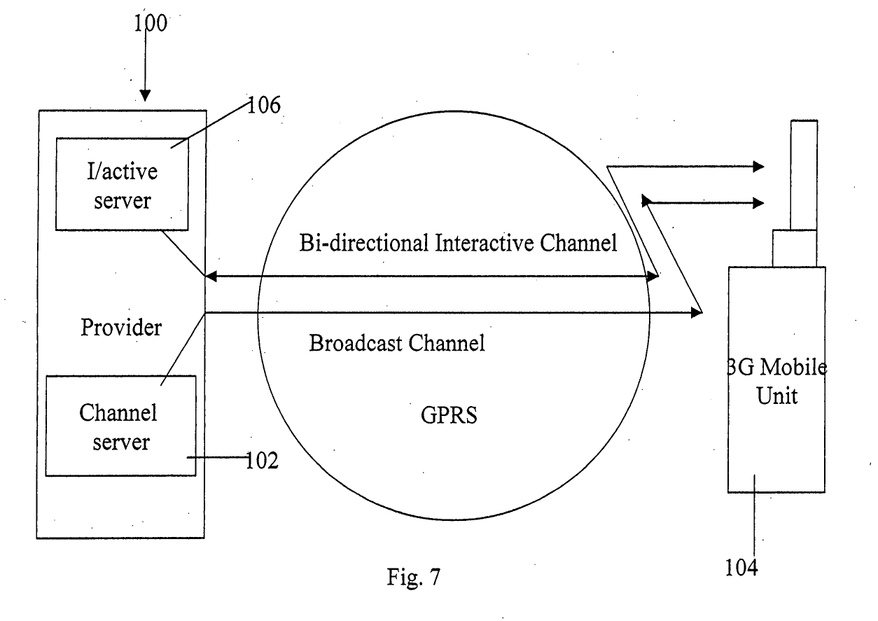

Reference is now made to FIG. 7, which is a simplified diagram illustrating how a music channel with interactive karaoke capabilities as described above may be provided over the cellular telephone infrastructure for playback on mobile telephones. The embodiment is particularly applicable to third generation (3G) mobile telephony devices which have the necessary bandwidth capacity. In FIG. 7, a provider 100 provides the music channel via a cellular compatible Internet site. A broadcast server 102 provides a data stream to any compatible mobile telephone 104 which connects to the server 102, using the general packet radio server (GPRS). The data stream preferably includes the data intensive parts of the service that are the same for all users. An interactive channel, also supplied via GPRS, provides the user with interactivity to convert the channel from a regular music channel into a karaoke game. The interactive channel is supported by interactive server 106 and allows the user to request removal of the vocal track and to add the lyrics and instructions as desired.

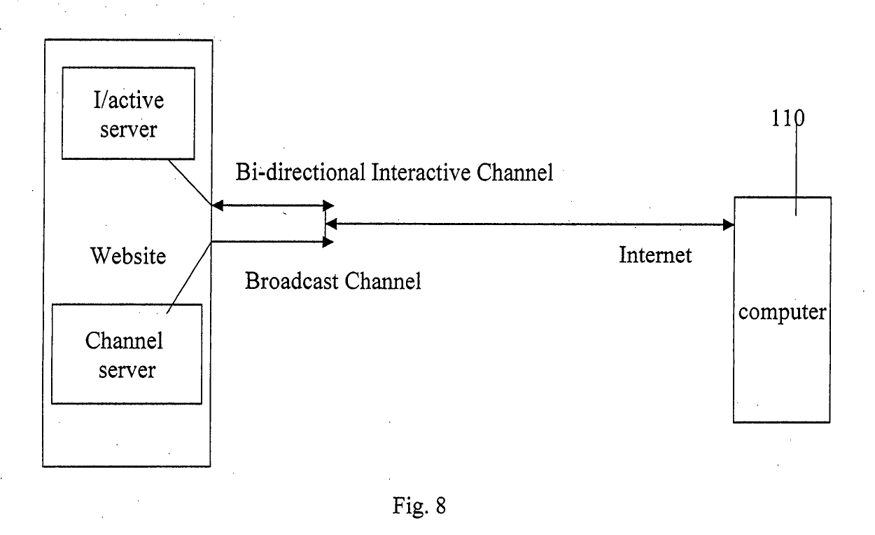

Reference is now made to FIG. 8, which is a simplified diagram illustrating how a music channel with interactive karaoke capabilities as described above may be provided over the Internet infrastructure for playback on Internet compatible devices such as multimedia computer 110. In FIG. 8, a provider 112 provides the music channel via a standard Internet website preferably based on HTML. A broadcast server 114 provides a data stream to any Internet user who connects to the server 114, using TCP/IP communication in the usual way. The data stream preferably includes the data intensive parts of the service that are the same for all users. An interactive channel, also supplied via TCP/IP, provides the user with interactivity to convert the channel from a regular music channel into a karaoke game. The interactive channel is supported by interactive server 116 and allows the user to request removal of the vocal track and to add the lyrics and instructions as desired. The interactive channel may also supply the animated character.

It is expected that during the life of this patent many relevant broadcasting and receiving devices and systems will be developed and the scope of the terms herein, particularly of the terms “television” and “broadcast”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A broadcast music channel for a one-to-many broadcasting infrastructure, said channel broadcasting at least vocal and instrumental parts of musical performances to currently connected users of said channel, said broadcast music channel supporting a user operated interactive control allowing each user independently to remove a vocal part of a current performance if desired.

2. The broadcast music channel of claim 1, wherein said channel further broadcasts a text part of a respective musical performance, said text part comprising at least one of lyrics of said performance and instructions for performing said lyrics.

3. The broadcast music channel of claim 2, configured to support an additional interactive control for including or removing said text part independently by each respective user.

4. The broadcast music channel of claim 3, wherein said channel comprises a plurality of text parts of said respective musical performance, said text parts being respectively different and selectable by said additional interactive control.

5. The broadcast music channel of claim 2, configured to use a one-to-many broadcast channel for delivering said vocal and instrumental parts to said users and to use an interactive channel to support said interactive control and to send said text part.

6. The broadcast music channel of claim 2, configured to use a one-to-many broadcast channel for delivering said vocal, said instrumental and said text parts to said users and to use an interactive channel to support said interactive control.

7. The broadcast music channel of claim 1, wherein said broadcast infrastructure is any one of a group comprising: terrestrial broadcasting infrastructure, cable television infrastructure, satellite broadcasting infrastructure, Internet infrastructure, a radio infrastructure and cellular telephony infrastructure.

8. The broadcast music channel of claim 1, further comprising a graphical broadcast part to accompany said performance.

9. The broadcast music channel of claim 1, further comprising a video performance part.

10. The broadcast music channel of claim 1, further comprising an animated broadcast part to accompany performances on said channel.

11. The broadcast music channel of claim 10, wherein said animated broadcast part is a figure having an operative connection to a music part of said broadcast to react to a beat of said music part.

12. The broadcast music channel of claim 10, wherein said animated part is user selectable from a plurality of characters.

13. The broadcast music channel of claim 12, wherein each of said user selectable characters has a different behavior profile.

14. A method for simultaneously providing a broadcast music channel and an interactive karaoke channel, to users at least some of whom are equipped with interactive control, comprising:
broadcasting a musical performance comprising a musical part and a vocal part to all current users of said channel, and
providing said interactively equipped users with an interactive control to remove said vocal part, independently of other viewers, thereby to view only said musical part of said performance.

15. The method of claim 14, further comprising providing a first text part of said performance, said text part comprising at least one of lyrics and performing instructions.

16. The method of claim 15, further comprising providing an interactive control for adding or removing said text part to said performance independently of other users.

17. The method of claim 16, further comprising providing at least one additional text part of a respective performance, said additional text part being different from said first text and selectable by interactive control as an alternative to said first text part.
